(19) United States
(12) Patent Application Publication
(10) Pub. No.: US 2003/0098841 A1
(43) Pub. Date: May 29, 2003

(54) Powered, remotely controllable computer display device

(76) Inventor: Jessica Broussard, Colorado Springs, CO (US)

Correspondence Address: HEWLETT-PACKARD COMPANY, Intellectual Property Administration, P.O. Box 272400, Fort Collins, CO, 80527-2400, US

(21) Appl. No.: 09/991,918

(22) Filed: Nov. 26, 2001

(51) Int. Cl. G09G 5/00

(52) U.S. Cl. 345/156

(57) ABSTRACT

A computer display device includes a display screen apparatus, a base adapted to rest on a support surface. The display screen apparatus tilts and swivels with respect to the base. A tilt drive electronically controls a tilt position of the display screen apparatus and a swivel drive electronically controls a swivel position. A user interface receives user inputs and controls the tilt drive and the swivel drive in response.

### FIELD OF THE INVENTION

The present invention relates generally to a computer display device, and more particularly to a powered, remotely controllable computer display device.

### BACKGROUND OF THE INVENTION

Computers play an important part in modern communications and data manipulation. Computers are widely used for many types of text processing, record keeping, electronic communications, design and automation, etc. Such applications may include the display of text, graphics, animations, videos, etc. Therefore, one of the important components of a computer system is a display. Because humans are highly visual and absorb information mainly through visual means, the computer display device consequently is an important part of a computer system.

There are many types of computer displays. The most common types are the cathode ray tube (CRT) display and the liquid crystal display (LCD), although new display technologies are being developed. The computer display may be connected to a personal computer, a computer work station, or may comprise a dumb network terminal. The computer sends electronic information to the display, and the display visually presents the data to the user or users.

In the prior art, a display screen is mounted to a fixed base. The display may be manually tilted or swiveled by the user. The prior art display also includes buttons or knobs that a user can employ to control the display characteristics, such as brightness, contrast, etc.

There are drawbacks to the computer display of the prior art. The manual adjustment of the computer display characteristics takes the user's concentration away from his or her task. The manual adjustment of the orientation of the computer display or the display characteristics may require the user to stop his or her task and look away from the contents of the display screen. Moreover, the prior art display may be positioned in an awkward location, such as on a shelf or in a computer desk or workbench. Therefore, the display may not be within easy reach of the user and may not be easily manually adjusted. Furthermore, the prior art display cannot be easily integrated into a home remote electronic set up.

Therefore, there remains a need in the art for improvements in computer display devices.

### SUMMARY OF THE INVENTION

A computer display device comprises a display screen apparatus, and a base adapted to rest on a flat surface. The display screen apparatus therefore tilts and swivels with respect to the base. A tilt drive electronically controls a tilt position of the display screen apparatus and a swivel drive electronically controls a swivel position. A user interface receives user inputs and controls the tilt drive and the swivel drive in response.

### BRIEF DESCRIPTION OF THE DRAWINGS

FIG. 1 shows a computer display according to one embodiment of the invention; and

FIG. 2 is a flowchart of a method for electronically controlling an orientation of a computer display according to another embodiment of the invention.

### DETAILED DESCRIPTION

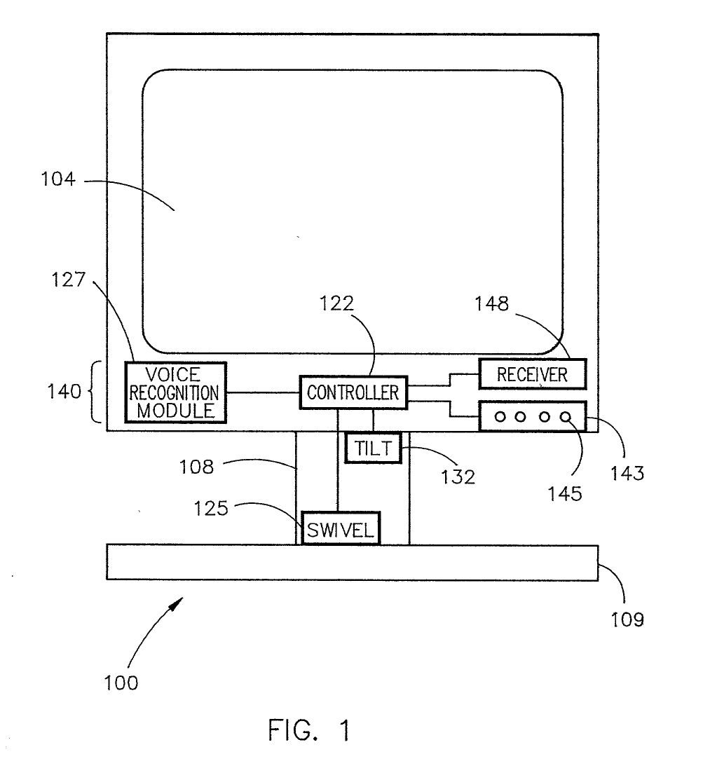

FIG. 1 shows a computer display 100 according to one embodiment of the invention. The computer display 100 includes a display screen apparatus 104, a base 109, a support member 108, a swivel drive 125, a tilt drive 132, and a user interface 140.

The display screen 104 may be any type of computer display, including a cathode ray tube (CRT) screen, a liquid crystal display (LCD) screen, a gas discharge plasma display screen, etc.

The base 109 may be any type of base adapted to sit on a flat surface, such as a bench, table, desk, wall (may be mounted to a wall), etc. The base 109 provides stability to the computer display 100. The support member 108 is connected to the base 109 and is movably attached to the display screen apparatus 104. As a result, the display screen apparatus 104 may tilt up and down and may swivel horizontally with respect to the base 109.

The swivel drive 125 and the tilt drive 132 may be any type of electronic drive mechanism, including electric motors and gears, a stepper motor, a servo motor, etc. The tilt drive 132 receives a control signal from the controller 122 and in response tilts the display screen apparatus 104. Likewise, the swivel drive 125 receives a control signal from the controller 122 and in response swivels the display screen apparatus 104. Both drives move the display screen apparatus 104 with respect to the support member 108 and the base 109. Alternately, the drives may move the apparatus 104 and the support member 108 with respect to the base 109.

It should be noted that although the swivel drive 125 and the tilt drive 132 are pictured as being located in the support member 108 and/or base 109, one or both of the drives could be located in the display screen apparatus 104.

The computer display of the invention may be used for any computer device that that employs a display device, such as personal computers (PCs), mainframes, network terminals, server devices, etc. In addition, the computer display may be employed with notebook or laptop computers that employ port extenders or docking stations in order to connect to an additional display screen.

The user interface 140 may include a manual input panel 143. The manual input panel 143 may include one or more manual display orientation input devices 145, such as buttons, switches, or knobs 145, that are used to control the swivel drive 125 and the tilt drive 132. These manual input devices therefore control the orientation of the display screen apparatus 104. As a result, a user may control the orientation of the display screen apparatus 104 through mechanical manipulation of the manual input panel 143. The manual display orientation input devices may be directly connected to the drives, or may be connected to a controller 122 that interprets inputs and controls the drives.

In addition to the controls discussed above, the computer display 100 may include one or more buttons, switches, knobs, etc. (not shown), that control the display characteristics of the display screen apparatus 104. The display characteristics may include brightness, contrast, color/tint, power on/off, display area height, display area width, display area vertical displacement, and display area horizontal displacement, for example. In addition, the display characteristics may optionally include a menu feature, including menu navigation and selection of a menu entry. These controls are typical for computer displays.

In an alternate embodiment, the user interface 140 includes a voice recognition module 127 and a controller 122. The voice recognition module 127 may include a microphone, analog-to-digital (A/D) converter, and voice processor, such as a digital signal processor (DSP). The voice recognition module 127 receives a voice input, converts it into an electronic signal, and extracts any voice commands in the voice signal. The voice commands may then be used by the controller 122 to control the swivel drive 125 and the tilt drive 132.

In another alternate embodiment, the user interface 140 includes a receiver 148 and a controller 122. The receiver 148 may communicate with one or more external remote control devices using, for example, radio frequency (RF) signals, infrared (IR) signals, etc., in order to receive orientation commands from these other devices. The receiver 148 demodulates these orientation commands, if needed, and passes them to the controller 122. The controller 122 receives the orientation commands and controls the swivel drive 125 and tilt drive 132 in response. The receiver 148 may receive these orientation commands from, for example, a remote control (not shown). The remote control may include a universal remote control for an audio/video set-up, or a specialized remote control for running the computer display 100. The receiver 148 may receive a wireless signal or alternatively may accept a wire connection and a wire-transmitted signal.

The receiver 148 may optionally receive and accept inputs from other computer devices, such as from a keyboard. This may be accomplished through use of a specialized keyboard driver in the computer operating system. The specialized keyboard driver may interpret predetermined keystroke combinations or dedicated key operations as orientation inputs and may form corresponding orientation input commands. The orientation input commands are relayed from the computer to the receiver 148 either wirelessly or through a wire link.

Therefore, the user may control the display device 100 through traditional manual input devices (i.e., buttons or knobs that control the display characteristics), a wireless remote control (may be a special or universal remote control), voice commands that are received and decoded by a voice recognition module, or by keyboard operations.

The computer display 100 of the invention advantageously offers a user the ability to power adjust and control the computer display 100. The computer display 100 furthermore offers the user the ability to remotely control the orientation and positioning of the computer display 100 (and optionally the display characteristics). In addition, the traditional manual controls for the display characteristics (discussed above) may also be included in any manner of voice recognition, remote control manipulation or keyboard activation of the computer display 100. Therefore, a voice command may optionally be used to power the computer display 100 on or off, for example.

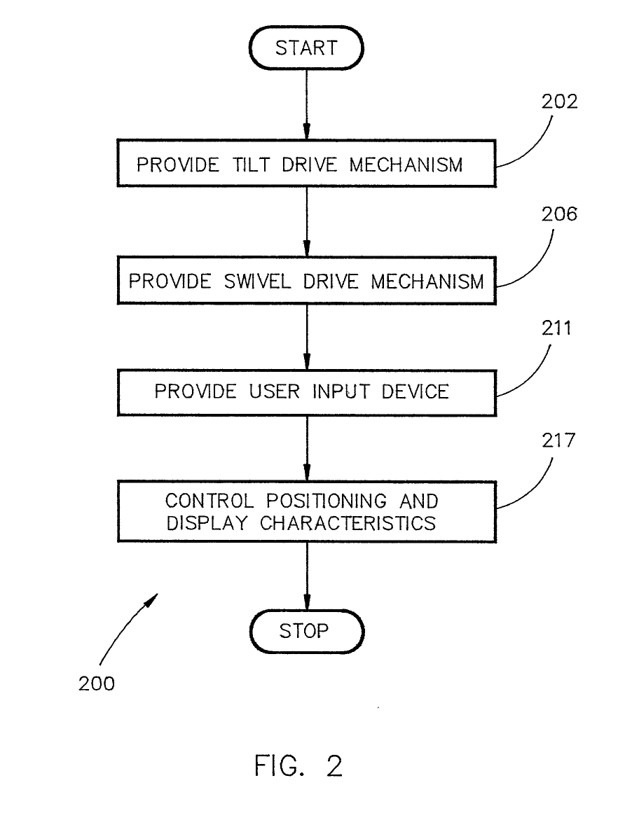

FIG. 2 is a flowchart 200 of a method for electronically controlling an orientation of a computer display 100 according to another embodiment of the invention. In step 202, a tilt drive mechanism is provided in the computer display 100.

In step 206, a swivel drive mechanism is also provided in the computer display 100. The two drive mechanisms may be any manner of power drive mechanisms and may employ electric motors and gears, stepper motors, servo motors, etc.

In step 211, a user interface is provided. The user interface may be one or more manual input devices, such as one or more buttons, knobs, etc., that can control the movement and orientation of the display device 100. Alternatively, the user interface may be a wireless receiver, such as a RF or IR receiver that receives commands from a remote device. The remote device may be a remote control or may be any other type of electronic component, such as a home audio/video and/or computer system. The receiver 148 may receive a wireless signal or alternatively may accept a wire connection and a wire-transmitted signal.

Alternatively, the user interface may be a voice command module that receives and decodes voice commands from the user in order to control the movement and orientation of the computer display 100. The user interface also may be responsive to keyboard commands.

In step 217, the user interface, in conjunction with the tilt drive 132 and swivel drive 125, controls the positioning of the computer display 100. Optionally, the voice recognition module 127 or the receiver 148 may also be used to control the display characteristics of the computer display 100.

The user does not have to manually position the computer display 100. This is advantageous in several situations, such as when the computer display is not easily accessible, when the user cannot reach it, or when the user is physically unable to manually reposition the computer display 100. In addition, the computer display of the invention is remotely adjustable and allows a user to adjust the computer display without actually having to grasp it.

The powered, remotely controllable computer display device provides several benefits for the user. Convenience is provided to the user, as the user can power adjust and remotely adjust the display with no need for the user to remove his or her hands from a keyboard or input device. Furthermore, there is no need for the user to remove his or her hands from the keyboard in order to adjust display characteristics. The computer display according to the invention may accommodate lighting changes during the day and accommodates ambient lighting and available space. The display may easily accommodate changes in the orientation or posture of the user, thus relieving user fatigue on stress caused by having to remain in the same position for long periods of time. Users may more easily shift position by using the powered display orientation control. It may be helpful for elderly users, for children, or users with infirmities.

We claim:

1. A computer display device, comprising:
a display screen apparatus;
a base adapted to rest on a substantially flat surface, whereby said display screen apparatus tilts and swivels with respect to said base;
a tilt drive that electronically controls a tilt position of said display screen apparatus;
a swivel drive that electronically controls a swivel position of said display screen apparatus; and
a user interface that is capable of receiving user inputs and controlling said tilt drive and said swivel drive in response.

2. The device of claim 1, wherein said user interface comprises one or more manual display characteristic input devices.

3. The device of claim 1, wherein said user interface comprises one or more manual display orientation input devices.

4. The device of claim 1, wherein said user interface comprises:
a controller; and
a voice recognition module that converts received speech into electronic user inputs.

5. The device of claim 1, wherein said user interface comprises:
a controller; and
a receiver capable of receiving orientation input commands.

6. The device of claim 1, wherein said user interface comprises:
a controller;
a wireless receiver capable of wirelessly receiving orientation input commands; and
an associated wireless remote control including one or more manual input devices.

7. A computer display device, comprising:
a display screen apparatus;
a base adapted to rest on a substantially flat surface;
a support member attached to said base and movably attached to said display screen apparatus wherein said display screen apparatus tilts and swivels with respect to said support member;
a tilt drive that electronically controls a tilt position of said display screen apparatus;
a swivel drive that electronically controls a swivel position of said display screen apparatus; and
a user interface means that is capable of receiving user inputs and controlling said tilt drive and said swivel drive in response.

8. The device of claim 7, wherein said user interface means comprises one or more manual display characteristic input means.

9. The device of claim 7, wherein said user interface means comprises one or more manual display orientation input means.

10. The device of claim 7, wherein said user interface means comprises:
a controller; and
a voice recognition means that converts received speech into electronic user inputs.

11. The device of claim 7, wherein said user interface means comprises:
a controller; and
a receiver means capable of receiving orientation input commands.

12. The device of claim 7, wherein said user interface means comprises:
a controller;
a wireless receiver means capable of wirelessly receiving orientation input commands; and
an associated wireless remote control means including one or more manual input devices.

13. A method for electronically controlling an orientation of a computer display, comprising the steps of:
providing a base adapted to rest on a support surface;
providing a tilt drive connected to said computer display and to said base;
providing a swivel drive connected to said computer display and to said base;
providing a user interface communicating with said tilt drive and said swivel drive and capable of receiving user inputs;
wherein said user interface controls said tilt drive and said swivel drive in response to said user inputs so as to move said computer display in tilt and swivel directions.

14. The method of claim 13, wherein said computer display is power-adjustable.

15. The method of claim 13, wherein said computer display is remotely adjustable.

16. The method of claim 13, wherein the step of providing said user interface comprises providing one or more display orientation manual input devices.

17. The method of claim 13, wherein the step of providing said user interface comprises providing one or more display characteristics manual input devices.

18. The method of claim 13, wherein the step of providing said user interface comprises providing a controller and a voice recognition module that converts received speech into electronic user inputs.

19. The method of claim 13, wherein the step of providing said user interface comprises providing a controller and a wireless receiver capable of wirelessly receiving orientation input commands.

20. The method of claim 13, wherein the step of providing said user interface comprises providing a controller, a wireless receiver capable of wirelessly receiving orientation input commands, and a wireless remote control including one or more manual input devices.
